(19) United States
(12) Patent Application Publication
(10) Pub. No.: US 2025/0137564 A1
(43) Pub. Date: May 1, 2025

(54) Irrigation Hose Connector and Connector Component

(71) Applicant: Cuixia Luo, Puning (CN)

(72) Inventor: Cuixia Luo, Puning (CN)

(21) Appl. No.: 18/387,863

(22) Filed: Nov. 8, 2023

(30) Foreign Application Priority Data
Oct. 27, 2023 (CN) 202322907710X

(51) Int. Cl. F16L 33/22; B05B 15/622; B05B 15/658

(52) U.S. Cl. CPC F16L 33/225; B05B 15/622; B05B 15/658

(57) ABSTRACT

An irrigation hose connector and connector component includes a fixing sleeve, limiting sleeve and pipe locking sleeve. The fixing sleeve is arrange outside a water source interface. The limiting sleeve is inserted into the water source interface and the end is integrally arranged with one end of the fixing sleeve. The limiting sleeve is provided with an activity space. The pipe locking sleeve is movablely arranged in the activity space of the limiting sleeve and one end is limited to the outside of the water source interface. A plurality of slottings are provided at intervals on the side wall of one end of the pipe locking sleeve. A locking part is arranged on the inner side wall of the pipe locking sleeve and between the two slottings.

### CROSS REFERENCE TO RELATED APPLICATION

This application claims priority to Chinese Patent Application 202322907710X, filed Oct. 27, 2023, the entire disclosure of which is incorporated herein in its entirety.

### FIELD OF THE INVENTION

The present utility patent is used in the technical field of plant cultivation, and in particular, for an irrigation hose connector and connector component.

### BACKGROUND OF THE INVENTION

In the process of plant cultivation and irrigation, a hose is usually used to connect the water source, such as a flow branch connector assembly, a faucet or a pump, so that the liquid can be transferred through the hose for irrigation purposes. In some cases, the hose end is usually plugged into the water source interface (such as a faucet) when irrigating vegetation, then use the liquid flowing out from the hose to irrigate the vegetation. When the water pressure is too large, the hose is easy to leave the water source interface under the action of pressure or the children's pulling, and the liquid splashing will affect the irrigation of the plants. Therefore, it is necessary to design a pipe connector and connector component that facilitate the stable connection between the hose and the water source interface for irrigation.

### DETAILED DESCRIPTION

Aiming at the defects and deficiencies of the prior art, an irrigation hose connector and connector component adopting in the present utility patent has the advantages of rapid connection, stable connection between the hose and the water source interface, and convenient disassembly between the hose and the water source interface.

To realize the above purposes, the technical solutions adopted by the present utility patent are: an irrigation hose connection, which is characterized in including a fixing sleeve which is arranged outside a water source interface; a limiting sleeve which is inserted into the water source interface and the end is integrally arranged with one end of the fixing sleeve, the limiting sleeve is provided with an activity space whose diameter gradually decreasing from inside to outside of the water source interface; and a pipe locking sleeve which is movablely arranged in the activity space of the limiting sleeve and one end is limited at the outside of the water source interface, a plurality of slottings are provided at intervals on the side wall of one end of the pipe locking sleeve, the slottings are limited in the activity space, a locking part is provided on the inner side wall of the pipe locking sleeve and between the two slottings.

A first clamping part is arranged on the inner side wall of the limiting sleeve near the opening end of the water source interface; a second clamping part, which is capable of fitting with the first clamping part to prevent the pipe locking sleeve from completely separating from the limiting sleeve, is arranged on the outer wall of the pipe locking sleeve near the opening end of the slotting.

A limiting convex edge with a diameter greater than an opening of the limiting sleeve is arranged on the outer side wall of the pipe locking sleeve away from the end of the second clamping part, an activity slot is formed between the limiting convex edge and the second clamping part.

A plurality of locking parts are enclosed in a ring.

The inner side wall of the fixing sleeve is provided with a circular fixing slot, the outer side wall of the water source interface is provided with a clamping convex edge matching with the fixing slot.

The fixing sleeve and the water source interface are secured by threading.

A connector component includes a connector body and an irrigation hose connector; wherein the connector body is provided with a water flow channel inside; wherein the connector body is uniformly provided with a plurality of water source interfaces connected with the water flow channel. The irrigation hose connector is arranged on the water source interface.

The connector body is provided with a pipe connector at both ends of the axis, the water flow channel runs through the pipe connector, the outer side wall of the end of the pipe connector is provided with a locking convex edge, the outer side wall of the pipe connector is provided with a fixing part with a diameter greater than the locking convex edge, one end of the hose can be fitted outside the locking convex edge and placed in a slot between the fixing part and the locking convex edge; the connector component further includes: a pipe bracing sleeve which is arranged outside the pipe connector and fixed by threading with the fixing part, and a bracing convex edge is arranged on the inner side wall of the pipe bracing sleeve matching with the locking convex edge to brace the hose.

A connector component includes an irrigation hose connector, an inserting rod and a spraying cover; wherein the top side wall of the inserting rod is provided with a water source interface; wherein the irrigation hose connector is arranged on the water source interface; and wherein the inside of the inserting rod is provided with a water flow channel to connect with the water source interface; wherein the spraying cover is arranged on the top of the inserting rod, and a plurality of spraying holes are arranged on the top of the spraying cover.

An installation slot is arranged on the top of the inserting rod, a positioning sleeve is arranged on the central axis position of the installation slot to connect with the water flow channel, and a flow divider sleeve is arranged in the spraying cover, which capable of being matching with the positioning sleeve, a flow divider column, which is inserted into the positioning sleeve, is arranged on the spraying cover and located in the flow divider sleeve, the height of the flow divider sleeve is lower than the height of the positioning sleeve, and the spraying hole is arranged at the edge of the top of the spraying cover, the spray hole is connected with the space between the installation slot and the flow divider sleeve.

Adopting the above technical solutions, the beneficial effect of the present utility patent is: an irrigation hose connection includes a fixing sleeve, a limiting sleeve and a pipe locking sleeve. The fixing sleeve is arranged outside a water source interface; the limiting sleeve is inserted into the water source interface and the end is integrally arranged with one end of the fixing sleeve, the limiting sleeve is provided with an activity space whose diameter gradually decreasing from inside to outside of the water source interface; and the pipe locking sleeve is movablely arranged in the the activity space of the limiting sleeve; and one end of the pipe is limited at the outside of the water source interface, a plurality of slottings are provided at intervals on the side wall of another end of the pipe locking sleeve, the slottings are limited in the activity space, a locking part is provided on the inner side wall of the pipe locking sleeve and between the two slottings. It should be noted that the fixing sleeve is arranged outside the water source interface so that the limiting sleeve and the pipe locking sleeve are inserted into the water source interface. At this time, the water source interface is inserted into the bracing slot, and then the hose is inserted into the pipe locking sleeve. Because the slotting end of the hose locking sleeve is driven by the action of its own restoring force to make the locking part locking with the hose, when the hose is pulled outward, the hose drives the pipe locking sleeve to move outward. As the diameter of the activity space of the limiting sleeve gradually decreases from inside to outside, the limiting sleeve squeezes the pipe locking sleeve so that the locking part further tightens the hose, thereby avoiding children pulling out the hose or the hose separates from the fixing sleeve under the action of water pressure thereby separating from the water source interface. When it is necessary to remove the hose from the water source interface, just press the pipe locking sleeve inward and pull the hose out, which can quickly connect the hose to the water source interface and facilitate the removal of the hose from the water source interface.

A connector component includes a connector body and an irrigation hose connector. A water flow channel is arranged in the connector body, and a plurality of water source interfaces are arranged on the connector body to communicate with the water flow channel, so as to facilitate the water diversion to irrigate more vegetation.

A connector component includes an irrigation hose connector, an inserting rod and a spraying cover, which frees user's hands.

### DESCRIPTION OF THE DRAWINGS

In order to more clearly illustrate the technical solutions of the embodiment or the prior art of the present invention, a brief introduction of the figures that need to be used in the embodiment or the description of the prior art will be given below, apparently, the figures in the following description are only some embodiments of the present invention, for those of general person skilled in the art, on the basis of no inventive efforts, other figures can also be obtained based on these figures.

FIG. 1 is a schematic view of embodiment 1;

FIG. 2 is a schematic view of another direction of embodiment 1;

FIG. 3 is a exploded view of embodiment 1;

FIG. 4 is a cross-sectional view of embodiment 1;

FIG. 5 is a schematic view of embodiment 2;

FIG. 6 is a exploded view of embodiment 2;

FIG. 7 is a cross-sectional view of embodiment 2;

FIG. 8 is a schematic view of embodiment 3;

FIG. 9 is a cross-sectional view of embodiment 3.

Reference signs in the figures: 1—fixing sleeve; 2—limiting sleeve; a—activity space; 3—pipe locking sleeve; b—slotting; 31—locking part; 21—first clamping part; 32—second clamping part; 33—limiting convex edge; c—activity slot; d—fixing slot; 4—water source interface; 41—clamping convex edge; 5—connector body; e—water flow channel; 51—pipe connector; 511—locking convex edge; 512—fixing part; 6—pipe bracing sleeve; 61—bracing convex edge; 7—inserting rod; 8—spraying cover; f—spraying hole; g—installation slot; 71—positioning sleeve; 81—flow divider sleeve; 82—flow divider column.

### DETAILED DESCRIPTION OF THE PREFERRED EMBODIMENTS

Below is a further detailed description of the present utility patent based on the figures.

The present embodiment only shows an explanation of the present utility patent and it is not a limitation to the present utility patent. The skilled in the art can make modifications to this embodiment as needed without making any creative contributions after reading this specification, which are always protected by the patent law as long as they are within the scope of the claims of the present utility patent.

It should be noted that when an element is called as being “fixed to” or “arranged on” another element, it can be directly on the other element or indirectly on the other element. When an element is called as being “connected to” another element, it can be directly connected to the other element or indirectly connected to the other element.

It should be noticed that the terms “length”, “width”, “top”, “bottom”, “front”, “rear”, “left”, “right”, “vertical”, “horizontal”, “top”, “bottom”, “inside” and “outside” which indicates the orientations or positional relationships are based on the orientations or positional relationships shown in the figures. They are only for facilitating describing the present invention and simplifying the description, rather than indicating or implying that the device or component must have a specific orientation, construct and operate in a specific orientation, therefore, it understood as a limitation of the present invention.

In addition, the terms “first” and “second” are used for descriptive purposes only and cannot be understood as indicating or implying relative importance or implicitly indicating the quantity of indicated technical features. Therefore, a feature defined as “first” and “second” may explicitly or implicitly include one or more of these features. In the description of the present invention, “a plurality of” means two or more, unless otherwise specifically defined.

### Embodiment 1

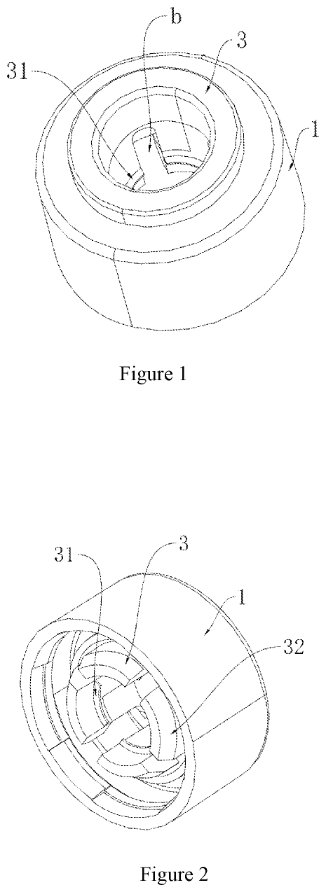

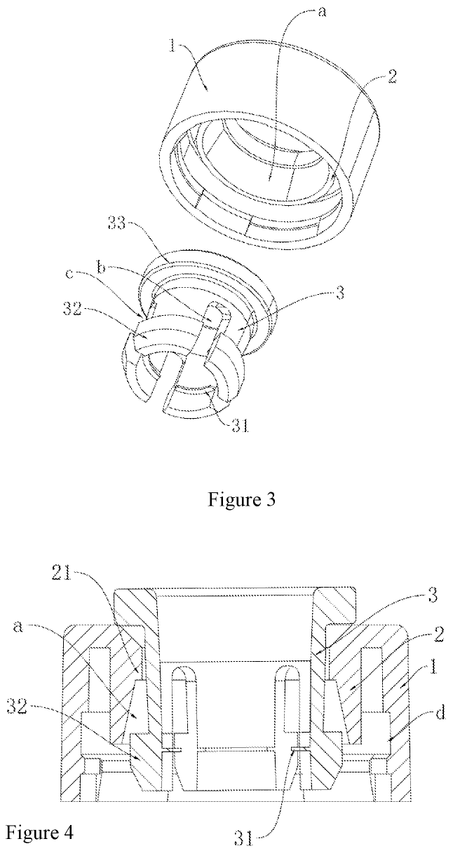

The present embodiment relates to an irrigation hose connector as shown in FIG. 1-4, including a fixing sleeve 1, a limited sleeve 2 and a pipe locking sleeve 3.

A fixing sleeve 1 is arranged outside a water source interface 4. A limiting sleeve 2 is inserted into the water source interface 4 and the end is integrally arranged with one end of the fixing sleeve 1, and the limiting sleeve 2 is provided with an activity space whose diameter gradually decreasing from inside to outside of the water source interface 4. Optionally, the thickness of the limiting sleeve 2 is gradually increased from the inside to outside of the water source interface 4. The limiting sleeve 2 and the fixing sleeve 1 are injected and fixed or molded together. A bracing slot for the water source interface 4 inserting is arranged between the fixing sleeve 1 and the limiting sleeve 2. A pipe locking sleeve 3 is movablely arranged in the activity space a of the limiting sleeve 2, and one end of the pipe is limited at the outside of the water source interface 4. A plurality of slottings are provided at intervals on another end of the side wall of the pipe locking sleeve 3, the slottings b are limited in the activity space a. A locking part 31 is provided on the inner side wall of the pipe locking sleeve 3 and between the two slottings b. The locking part 31 is curved slice shape. In the present embodiment, a plurality of locking part 31 are enclosed in a ring. Four locking parts 31 and four slottings b are configured. In other embodiments, the locking part 31 and slotting b are provided with the quantity of 2, 3, or 5, etc. Optionally, the locking part 31 is integrated with the inner side wall of the pipe locking sleeve 3. Optionally, the locking part 31 is a curved metal elastic part embedded in the inner aide wall of the pipe locking sleeve 3.

It should be noted that the fixing sleeve 1 is arranged outside the water source interface 4 so that the limiting sleeve 2 and the pipe locking sleeve 3 are inserted into the water source interface 4. At this time, the water source interface 4 is inserted into the bracing slot, and then the hose is inserted into the pipe locking sleeve 3. Because the end of the hose locking sleeve which is provided with a slotting b is under the action of its own restoring force to make the locking part 31 fastening the hose, when the hose is pulled outwards, the hose drives the pipe locking sleeve 3 to move outwards. As the diameter of the activity space a of the limiting sleeve 2 gradually decreases from inside to outside, the limiting sleeve 2 squeeges the pipe locking sleeve 3, thereby making the locking part 31 further fasten the hose, so that prevent the hose from pulling out by children or from separating from the fixing sleeve 1 and then separating from the water interface 4 under the action of water pressure. When it is necessary to remove the hose from the water source connector 4, just press the pipe locking sleeve 3 inward and pull the hose outward. The hose can be quickly connected to the water source connector 4 and easily removed from the water source connector 4.

It should be noted that the fixing sleeve 1 is arranged outside the water source interface 4 so that the limiting sleeve 2 and the pipe locking sleeve 3 are inserted into the water source interface 4. At this time, the water source interface 4 is inserted into the bracing slot, and then the hose is inserted into the pipe locking sleeve 3. Because the end of the hose locking sleeve which is provided with a slotting b is under the action of its own restoring force to make the locking part 31 fastening the hose, when the hose is pulled outwards, the hose drives the pipe locking sleeve 3 to move outwards. As the diameter of the activity space a of the limiting sleeve 2 gradually decreases from inside to outside, the limiting sleeve 2 squeeges the pipe locking sleeve 3, thereby making the locking part 31 further fasten the hose, so that prevent the hose from pulling out by children or from separating from the fixing sleeve 1 and then separating from the water interface 4 under the action of water pressure. When it is necessary to remove the hose from the water source connector 4, just press the pipe locking sleeve 3 inward and pull the hose outward. The hose can be quickly connected to the water source connector 4 and easily removed from the water source connector 4.

Optionally, the outer side wall of the pipe locking sleeve 3 away from the end of the second clamping part 32 is provided with a limiting convex edge 33 whose diameter is greater than the limiting sleeve 2, and an activity slot c is formed between the limiting convex edge 33 and the second clamping part 32, so that the first locking part 31 can move in the activity slot c to avoid excessive insertion of the pipe locking sleeve 3 into the limit sleeve 2.

Optionally, the outer side wall of the pipe locking sleeve 3 away from the end of the second clamping part 32 is provided with a limiting convex edge 33 whose diameter is greater than the limiting sleeve 2, and an activity slot c is formed between the limiting convex edge 33 and the second clamping part 32, so that the first locking part 31 can move in the activity slot c to avoid excessive insertion of the pipe locking sleeve 3 into the limit sleeve 2.

### Embodiment 2

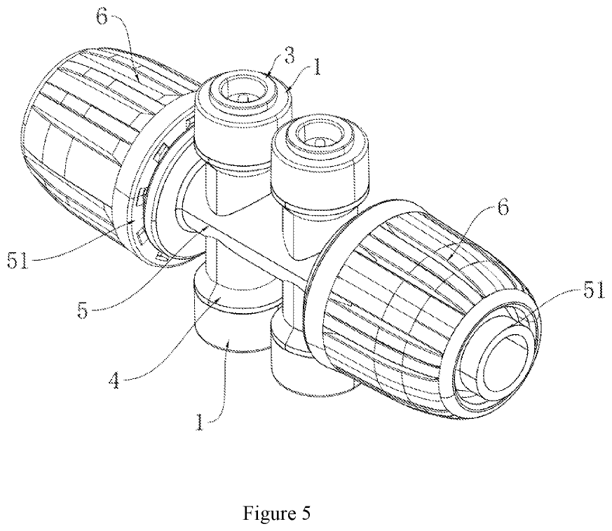

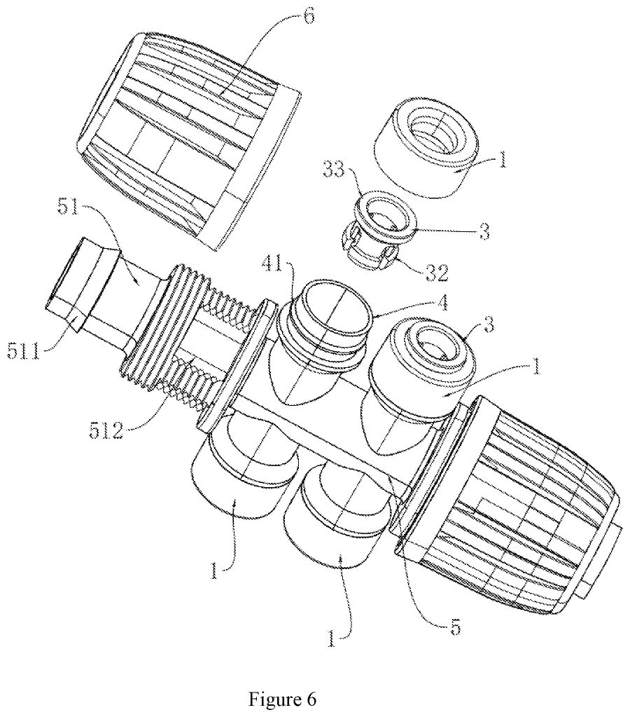

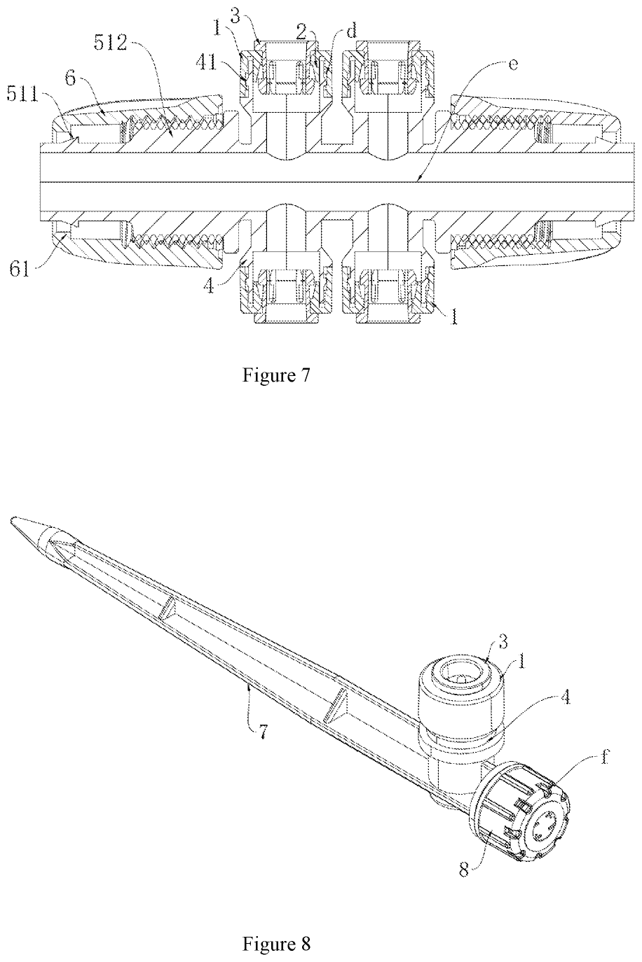

The present embodiment is based on the irrigation hose connector of Embodiment 1, a connector component, as shown in FIG. 5-7, in order to facilitate the diversion of water sources to irrigate more vegetation, includes a connector body 5 and an the irrigation hose connector, wherein the connector body 5 is provided with a water flow channel e inside, and a plurality of water source interfaces 4 connecting with water flow channel e are arranged on the connector body 5. The irrigation hose connector is arranged on the water source connector 4. Optionally, the connector body 5 is provided with four water source interfaces 4, and the water source interface 4 is symmetrically arranged on both sides of the interface body, thereby facilitating the water diversion to irrigate more plants. In the present embodiment, the water source interface 4 is integrated with the connector body 5. In other embodiments, a plurality of water source interfaces, such as 2, 3, and 5, are arranged on the connector body 5.

Optionally, the connector body 5 is provided with a pipe connector 51 at both ends of the axis, the water flow channel e runs through the pipe connector 51, the outer side wall of the end of the pipe connector 51 is provided with a locking convex edge 511, and the outer side wall of the pipe connector 51 is provided with a fixing part 512 whose diameter is greater than the locking convex edge 511. One end of the hose can be fitted outside the locking convex edge 511 and placed in a slot between the fixing part 512 and the locking convex edge 511. The connector component further includes a pipe bracing sleeve 6, which is sheathing outside the pipe connector 51 and is threaded to the fixing part 512, and a bracing convex edge 61 is arranged on the inner side wall of the pipe bracing sleeve 6 to match with the locking convex edge 511 so as to brace the hose tightly.

### Embodiment 3

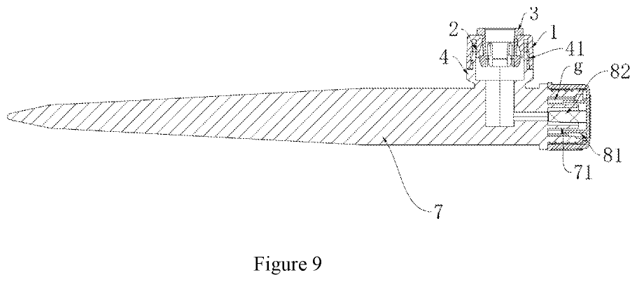

The present embodiment is based on the irrigation hose connector of Embodiment 1, and the main difference from Embodiment 2 is, as shown in FIG. 8-9, for the convenience of freeing the user's hands, a connector component includes: an irrigation hose connector, an inserting rod 7 and a spraying cover 8. The side wall of the top of the inserting rod 7 is provided with a water source interface 4. The hose connector is arranged on the water source interface 4, a water flow channel e is arranged in the inserting rod 7 to connect with the water source interface 4. The spraying cover 8 is arranged on the top of the inserting rod 7, and a plurality of spray holes f is arranged on the top of the spraying cover 8. In the present embodiment, the inserting rod 7 is cone shaped. A outlet slot is arranged on the outer side wall of the inserting rod 7. Optionally, the cross section of the inserting rod 7 is cross-shaped, V-shaped or Y-shaped. In order to facilitate the insertion and fixation of the inserting rod 7, such as inserting into the soil and then spraying, the end of the inserting rod 7 away from the spraying cover 8 is conical. It should be noted that Embodiment 2 and Embodiment 3 can be used in combination to form an irrigation system.

### Embodiment 3

The present embodiment is based on the irrigation hose connector of Embodiment 1, and the main difference from Embodiment 2 is, as shown in FIG. 8-9, for the convenience of freeing the user's hands, a connector component includes: an irrigation hose connector, an inserting rod 7 and a spraying cover 8. The side wall of the top of the inserting rod 7 is provided with a water source interface 4. The hose connector is arranged on the water source interface 4, a water flow channel e is arranged in the inserting rod 7 to connect with the water source interface 4. The spraying cover 8 is arranged on the top of the inserting rod 7, and a plurality of spray holes f is arranged on the top of the spraying cover 8. In the present embodiment, the inserting rod 7 is cone shaped. A outlet slot is arranged on the outer side wall of the inserting rod 7. Optionally, the cross section of the inserting rod 7 is cross-shaped, V-shaped or Y-shaped. In order to facilitate the insertion and fixation of the inserting rod 7, such as inserting into the soil and then spraying, the end of the inserting rod 7 away from the spraying cover 8 is conical. It should be noted that Embodiment 2 and Embodiment 3 can be used in combination to form an irrigation system.

The above only aims to illustrate the technical solution of the present utility patent without limitation. Any other modifications or equivalent replacements of the technical solution of the present utility patent made by ordinary skilled in the art should be included in the scope of the claims of the present utility patent as long as they do not deviate from the technical solution spirit and scope of the present utility patent.

1. An irrigation hose connector is characterized in including: a fixing sleeve (1) which is arranged outside a water source interface (4); a limiting sleeve (2) which is inserted into the water source interface (4) and the end is integrally arranged with one end of the fixing sleeve (1), the limiting sleeve (2) is provided with an activity space (a) whose diameter gradually decreasing from inside to outside of the water source interface (4); and a pipe locking sleeve (3) which is movablely arranged in the activity space (a) of the limiting sleeve (2) and one end is limited to the outside of the water source interface (4), a plurality of slottings are arranged at intervals on the side wall of one end of the pipe locking sleeve (3), the slottings (b) are limited in the activity space (a), a locking part (31) is arranged on the inner side wall of the pipe locking sleeve (3) and between the two slottings (b).

2. The irrigation hose connector according to claim 1, is characterized in, a first clamping part (21) is arranged on the inner side wall of the limiting sleeve (2) near the open end of the water source interface (4); a second clamping part (32), which is capable of fitting with the first clamping part (21) to prevent the pipe locking sleeve (3) from completely separating from the limiting sleeve (2), is arranged on the outer wall of the pipe locking sleeve (3) near to the end of an opening of the slotting (b).

3. The irrigation hose connector according to claim 2, is characterized in, a limiting convex edge (33) with a diameter greater than an opening of the limiting sleeve (2) is arranged on the outer side wall of the pipe locking sleeve (3) away from the end of the second clamping part (32), an activity slot (c) is formed between the limiting convex edge (33) and the second clamping part (32).

4. The irrigation hose connector according to claim 1, is characterized in, a plurality of locking parts (31) are enclosed in a ring.

5. The irrigation hose connector according to claim 4, is characterized in, the inner side wall of the fixing sleeve (1) is provided with a circular fixing slot (d), the outer side wall of the water source interface (4) is provided with a clamping convex edge (41) to match with the fixing slot (d).

6. The irrigation hose connector according to claim 4, is characterized in, the fixing sleeve (1) and the water source interface (4) are secured by threading.

7. A connector component is characterized in including a connector body (5) and an irrigation hose connector, wherein the connector body (5) is provided with a water flow channel (e) inside, the connector body (5) is uniformly provided with a plurality of water source interfaces (4) to connect with the water flow channel (e); wherein the irrigation hose connector includes a fixing sleeve (1), limiting sleeve (2) and a pipe locking sleeve (3), wherein the fixing sleeve (1) is arranged outside the water source interface (4); wherein the limiting sleeve (2) is inserted into the water source interface (4) and the end is integrated with one end of the fixing sleeve (1), the limiting sleeve (2) is provided with an activity space (a) whose diameter gradually decreasing from inside to outside of the water source interface (4); wherein a pipe locking sleeve (3) is movablely arranged in the activity space (a) of the limiting sleeve (2), and one end is limited at the outside of the water source interface (4), a plurality of slottings are provided at intervals on the side wall of one end of the pipe locking sleeve (3), the slottings (b) are limited in the activity space (a), a locking part (31) is provided on the inner side wall of the pipe locking sleeve (3) and between the two slottings (b).

8. The connector component according to claim 7 is characterized in, the connector body (5) is provided with a pipe connector (51) along with the two ends of the axis, the water flow channel (e) runs through the pipe connector (51), the outer side wall of the end of the pipe connector (51) is provided with a locking convex edge (511), the outer side wall of the pipe connector (51) is provided with a fixing part (512) with a diameter greater than the locking convex edge (511), one end of the hose can be fitted outside a locking convex edge (511) and placed in a slot between the fixing part (512) and the locking convex edge (511); the connector component further includes: a pipe bracing sleeve (6) which is arranged outside the pipe connector (51) and fixed by threading with the fixing part (512), and a bracing convex edge (61) which is arranged on the inner side wall of the pipe bracing sleeve (6) in conjunction with the locking convex edge (511) to brace the hose.

9. A connector component is characterized in including an irrigation hose connector, an inserting rod (7) and a spraying cover (8); wherein the top side wall of the inserting rod (7) is provided with a water source interface (4), wherein the irrigation hose connector is arranged on the water source interface (4), and wherein the inside of the inserting rod (7) is provided with a water flow channel (e) communicated with the water source interface (4); the irrigation hose connector includes a fixing sleeve (1), a limiting sleeve (2) and a pipe locking sleeve (3); wherein the fixing sleeve (1) is arranged outside of the water source interface (4); where in the limiting sleeve (2) is inserted into the water source interface (4) and the end is integrated with one end of the fixing sleeve (1), an activity space (a) whose diameter gradually decreasing from inside to outside of the water source interface (4) is arranged in the limiting sleeve (2); wherein a pipe locking sleeve (3) is movablely arranged in the activity space (a) of the limiting sleeve (2) and one end is limited at the outside of the water source interface (4), a plurality of slottings are provided at intervals on the side wall of one end of the pipe locking sleeve (3), the slottings (b) are limited in the activity space (a), a locking part (31) is provided on the inner side wall of the pipe locking sleeve (3) and between the two slottings (b); wherein the spraying cover (8) is arranged on the top of the inserting rod (7), and a plurality of spraying holes (f) are arranged on the top of the spraying cover (8).

10. The connector component according to claim 9 is characterized in, an installation slot (g) is arranged on the top of the inserting rod (7), a positioning sleeve (71) is arranged on the central axis position of the installation slot (g) to connect with the water flow channel (e), and a flow divider sleeve (81) is arranged in the spraying cover (8), which capable of being matching with the positioning sleeve (71), a flow divider column (82) is arranged on the spraying cover (8) and located in the flow divider sleeve (81) to insert into the positioning sleeve (71), the height of the flow divider sleeve (81) is lower than the height of the positioning sleeve (71), and the spraying hole (f) is arranged at the edge of the top of the spraying cover (8), the spray hole (f) is connected with the space between the installation slot (g) and the flow divider sleeve (81).
